(19) United States
(12) Patent Application Publication
(10) Pub. No.: US 2022/0318389 A1
(43) Pub. Date: Oct. 6, 2022

(54) TRANSFORMING DATAFLOWS INTO SECURE DATAFLOWS USING TRUSTED AND ISOLATED COMPUTING ENVIRONMENTS

(71) Applicant: SafeLiShare, Inc., Morristown, NJ (US)

(72) Inventors: Shamim A. Naqvi, Morristown, NJ (US); Pramod V. Koppol, Freehold, NJ (US)

(21) Appl. No.: 17/714,666

(22) Filed: Apr. 6, 2022

Related U.S. Application Data
(60) Provisional application No. 63/171,291, filed on Apr. 6, 2021.

(51) Int. Cl. G06F 21/57; G06F 16/25; G06F 21/62; G06F 21/60; G06N 3/04

(52) U.S. Cl. CPC G06F 21/57; G06F 16/254; G06F 21/6245; G06F 21/602; G06N 3/0454; G06F 2221/034

(57) ABSTRACT

Systems and methods are presented for processing a dataset in a sequence of steps that define at least a portion of a data pipeline. The method includes: providing a plurality of trusted and isolated computing environments; providing one or more algorithms in each of the trusted and isolated computing environments, the one or more algorithms in each of the trusted and isolated computing environments being configured to process data in accordance with a different step in the data pipeline; receiving the dataset in a first of the trusted and isolated computing environments and causing the dataset to be processed by the one or more algorithms therein to produce a first processed output dataset; and causing the first processed output dataset to be processed in a second of the trusted and isolated computing environments by the one or more algorithms therein.

### CROSS-REFERENCE TO RELATED APPLICATIONS

This application claims the benefit of U.S. Provisional Application Ser. No. 63/171,291, filed Apr. 6, 2021, the contents of which are incorporated herein by reference.

### FIELD OF THE INVENTION

The present invention relates generally to protecting data privacy and intellectual property, and to provide plausible deniability to providers of computing services, thereby providing some measure of relief from privacy and data regulations.

### BACKGROUND

The Internet/web supports an enormous number of devices that have the ability to collect data about consumers, their habits and actions, and their surrounding environments. Innumerable applications utilize such collected data to customize services and offerings, glean important trends, predict patterns, and train classifiers and pattern-matching computer programs.

The utility and potential benefit of applications analyzing user provided data to consumers and society, in general, is clear. However, there is a growing concern of privacy of user data. This is especially true when user's health data is collected and analyzed. Additionally, service providers themselves have a concern to abide by and satisfy privacy regulations.

Therefore, a technology that would protect data and algorithms that process data and provide service providers with a mechanism to satisfy privacy regulations in a relatively easy manner would be of significant benefit to commercial activities and members of society.

### SUMMARY

In accordance with one aspect of the systems and techniques described herein, a method is presented for processing a dataset in a sequence of steps that define at least a portion of a data pipeline. The method includes: providing a plurality of trusted and isolated computing environments, wherein a trusted computing environment is a computing environment whose computer code is able to be attested by comparing a digest of the computing environment to a baseline digest of the computing environment that is available to third parties to thereby verify computing environment integrity, an isolated computing environment being a computing environment in which only a specified maximum number of application processes and specified system processes implementing the computing environment are able to operate; providing one or more algorithms in each of the trusted and isolated computing environments, the one or more algorithms in each of the trusted and isolated computing environments being configured to process data in accordance with a different step in the data pipeline; receiving the dataset in a first of the trusted and isolated computing environments and causing the dataset to be processed by the one or more algorithms therein to produce a first processed output dataset; and causing the first processed output dataset to be processed in a second of the trusted and isolated computing environments by the one or more algorithms therein.

In accordance with another aspect of the systems and techniques described herein, the sequence of steps in the data pipeline performed in the plurality of trusted and isolated computing environments define a segment of a larger data pipeline that includes one or more additional data processing steps.

In accordance with another aspect of the systems and techniques described herein, the plurality of trusted and isolated computing environments includes at least three trusted and isolated computing environments, the data pipeline processing the dataset in accordance with an E-T-L (Extraction-Transformation-Load) dataflow such that an extraction step, a transformation step and a load step are each performed in a different one of the trusted and isolated computing environments.

In accordance with another aspect of the systems and techniques described herein, the dataset provided in the first trusted and isolated computing environment is provided by a third party different from a third party providing the one or more algorithms provided in the first trusted and isolated computing environment, the third parties both being different from a system operator or operators of the plurality of trusted and isolated computing environments.

In accordance with another aspect of the systems and techniques described herein, the extraction step obtains data for processing from user computing devices and stores the data in encrypted form.

In accordance with another aspect of the systems and techniques described herein, a method is presented for processing data in a sequence of steps that define at least a portion of a data pipeline. The method includes: providing at least three trusted and isolated computing environments, wherein a trusted computing environment is a computing environment whose computer code is able to be attested by comparing a digest of the computing environment to a baseline digest of the computing environment that is available to third parties to thereby verify computing environment integrity, an isolated computing environment being a computing environment in which only a specified maximum number of application processes and specified system processes implementing the computing environment are able to operate; providing one or more algorithms in each of the trusted and isolated computing environments, the one or more algorithms in each of the trusted and isolated computing environments being configured to process data in accordance with a different step in the data pipeline; receiving a first dataset in a first of the trusted and isolated computing environments and causing the first dataset to be processed by the one or more algorithms therein to produce a first processed output dataset, at least one of the algorithms processing the first dataset in the first trusted and isolated computing environment being a first Deep Learning Neural Network (DLNN) program; receiving a second dataset in a second of the trusted and isolated computing environments and causing the second dataset to be processed by the one or more algorithms therein to produce a second processed output dataset, at least one of the algorithms processing the second dataset in the second trusted and isolated computing environment being a second DLNN program; and causing the first and second processed output datasets to be processed in a third of the trusted and isolated computing environments by the one or more algorithms therein.

In accordance with another aspect of the systems and techniques described herein, the first and second processed output datasets include values for internal weights of the first and second DLNN programs.

In accordance with another aspect of the systems and techniques described herein, at least one of the algorithms in the third trusted and isolated computing environment is a third DLNN program that combines the internal weights of the first and second DLNN programs and provides the combined internal weights to a fourth trusted and isolated computing environment that has a fourth DLNN program for processing the combined internal weights.

In accordance with another aspect of the systems and techniques described herein, method is presented for establishing an encryption/decryption process for communicating messages between at least one sending computing device and at least one receiving computing device over a data pipeline that includes a plurality of point of presence (POP) access points and a routing network. The method includes: negotiating use of one or more specified encryption/decryption keys between the sending computing device and a first algorithm operating in a first trusted and isolated computing environment that communicates with one of the POP access points, the one or more specified encryption/decryption keys being used to encrypt messages sent by the sending computing device to the receiving computing device, wherein a trusted computing environment is a computing environment whose computer code is able to be attested by comparing a digest of the computing environment to a baseline digest of the computing environment that is available to third parties to thereby verify computing environment integrity, an isolated computing environment being a computing environment in which only a specified maximum number of application processes and specified system processes implementing the computing environment are able to operate; and negotiating use of one or more specified decryption/encryption keys between the receiving computing device and a second algorithm operating in a second trusted and isolated computing environment that communicates with one of the POP access points, the one or more specified decryption/encryption keys being used to decrypt messages by the receiving computing device from the sending computing device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a data flow sequence representing an Extract-Transform-Load (ETL) dataflow.

FIG. 2 shows a data flow sequence representing an Extract-Load-Transform (ELT) dataflow.

FIG. 3 shows a sequence representing a Transform-Extract-Load (TEL) dataflow.

FIG. 4 shows a computing arrangement having a trusted computing environment.

FIG. 5 shows an example of method for trusting the computing environment of FIG. 4.

FIG. 6A shows one example of a single secure pipeline primitive, which is based on the secure computing environment described in connection with FIG. 4; and FIG. 6B shows a message flow diagram illustrating a method for creating a secure data pipeline such as shown in FIG. 6A.

FIG. 7A shows an arrangement in which a control plane creates a secure pipeline comprising two secure data plane environments; FIG. 7B shows a simplified representation of the secure pipeline depicted in FIG. 7A; FIG. 7C shows a further simplified representation of the secure pipeline depicted in FIG. 7A; FIG. 7D shows a simplified representation of an alternative secure pipeline that has a directed acyclic graph (DAG) inter-connection topology; and FIG. 7E shows the simplified representation of FIG. 7D without the control plane.

FIG. 8A shows a simplified representation of the extraction step of a secure pipeline; FIG. 8B shows a simplified representation of the transformation step of a secure pipeline; and FIG. 8C shows a simplified representation of the loading step of a secure pipeline.

FIG. 9A shows a data flow for a typical service offering concerning crowd sourced data (CSD) applications; FIG. 9B shows how the pipeline of FIG. 9A can be transformed into a secure pipeline; FIG. 9C shows a simplified representation of the secure pipeline shown in FIG. 9B; FIG. 9D shows the secure pipeline of FIG. 9C but with two of the pipeline primitives being combined into a single pipeline primitive; and FIG. 9E shows a simplified representation of the secure pipeline of FIG. 9A.

FIG. 10A shows an example of a pipeline in which a dataset being provided to a computer program (e.g., an app) that produces a result (i.e., a trained model); FIG. 10B shows the secure pipeline that corresponds to the pipeline of FIG. 10A; and FIG. 10C show the simplified pipeline representation of the secure pipeline of FIG. 10B.

FIG. 11A shows another pipeline in which two data sets are made available to algorithm 1103 that produces a trained model as output; FIG. 11B shows the corresponding secure pipeline and FIG. 11C shows its simplified representation.

FIG. 12A shows another example of a pipeline that is data intensive and which receives the assets to be processed from two different customers; FIG. 12B shows another example of a data intensive pipeline in which the assets to be processed are received from two different customers in two different jurisdictions; and FIG. 12C shows a secure pipeline implementation of the processes shown in FIG. 12B in which the computing environments are now secure computing environments.

FIG. 13A shows a pipeline for a one-to-one message service offered by a messaging system in which a sender transmits a message from one user computing device to another user computing device; FIG. 13B shows another messaging system pipeline for a group chat service; and FIG. 13C shows a group chat service pipeline that uses secure computing environments to ensure that the service provider remains oblivious to the message content being shared in a group chat.

### DETAILED DESCRIPTION

### Introduction

Various mobile and nonmobile user computing devices such as smart phones, personal digital assistants, fitness monitoring devices, digital (surveillance) cameras, smart watches, IoT devices such as smart thermostats and doorbells, etc., often contain one or more sensors to monitor and collect data on the actions, environment, surroundings, homes, and health status of users. Consumers routinely download numerous application software products (“apps”) onto their computing devices and use these apps during their daily lives. Consumers who contribute data concerning these activities while using these apps have expressed privacy concerns.

Many enterprises acquire and use datasets to provide services to their customers. In some cases, the datasets are collected by the enterprises themselves while in other cases, the enterprises acquire datasets from so-called data providers. It has been speculated in the general press that data monetization represents a growing area of commercial concern to many owners of datasets. Owners of datasets would understandably like to protect their data from being copied or distributed without authorization.

In a nascent area of commercial interest, enterprises acquire algorithms (embodied in e.g., computer programs), to process data. For example, many machine learning (ML) programs have been made available via open-source methods for general use. Owners of computer programs that are provided to third parties would like to protect their intellectual property since it can take large amounts of effort and resources to design such programs.

Service providers are entities that often use computer programs, datasets and computing machinery to provide services to their customers. A growing number of regulations require the service providers to protect data privacy and intellectual property of assets. Movements of datasets across national boundaries may be prohibited. Revealing personal information may engender legal risk to an enterprise. Certain regulations that have been enacted in recent years to offer such protections to data and other digital assets include HIPPA (Health Insurance Portability and Accountability Act 1996), GDPR (General Data Protection Regulations), PSD2 (Revised Payment Services Directive), CCPA (California Consumer Privacy Act 2018), etc.

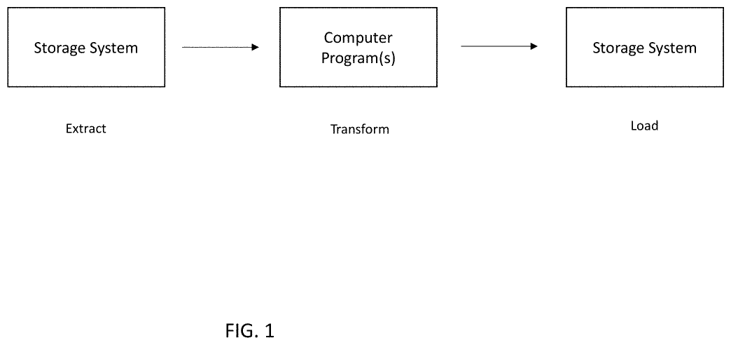

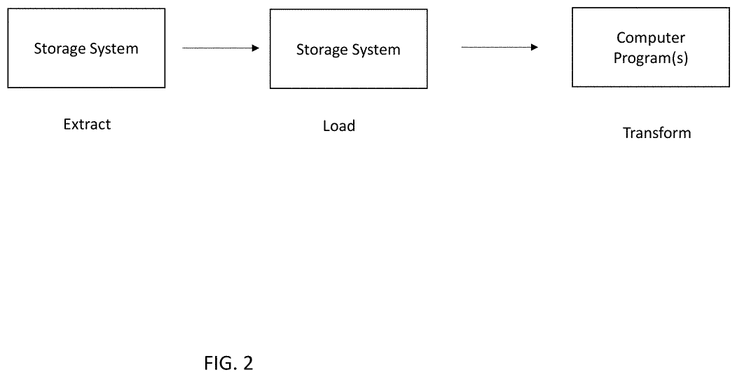

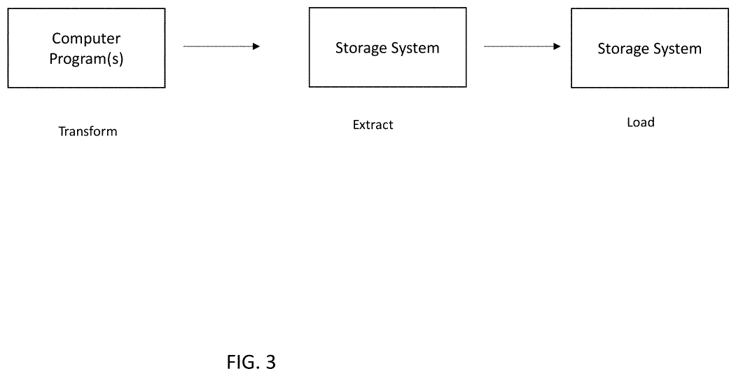

Many service providing infrastructures use data flows such as those shown in FIGS. 1, 2 and 3. FIG. 1 shows a sequence representing an Extract-Transform-Load (ETL) dataflow. FIG. 2 shows a sequence representing an ELT dataflow. FIG. 3 shows a sequence representing a TEL dataflow.

In computing, ETL is the general procedure of copying data from one or more sources into a destination system which represents the data differently from the source(s) or in a different context than the source(s). That is, in an ETL dataflow, data is extracted (e.g., from user computing devices or, as shown in FIGS. 1-3, a data storage system), transformed (e.g., personal information such as social security numbers may be removed) and loaded into e.g., a storage processing unit for use by another system (or another dataflow). As an example, a healthcare dataset may use the “extraction and transform” steps to clean or de-anonymize data collected from patients before “loading” it into a storage system for further processing. ETL dataflows are quite common in conventional service provisioning systems.

The ELT dataflow is a variation of the ETL dataflow in which the transformation step is performed after the data has been extracted and loaded. For example, data extracted from consumer devices may be loaded into a (e.g., cloud-based) data warehouse before being transformed for use by particular applications.

The TEL dataflow is another variation of the ETL dataflow wherein the data is transformed at its source before it is extracted and loaded for further use by applications. As an example, cryptocurrency tokens may be “burned” at their source (e.g., on a blockchain) before relevant data is extracted and loaded into a new system for further processing.

Multiple ETL, ELT and TEL dataflows may be interconnected in a variety of ways to achieve a certain service provisioning and several variations of these dataflows may also be envisioned.

Since ETL, ELT and TEL dataflows occur in many commercial service provisioning infrastructures, it will be of commercial benefit to transform or design anew the dataflow infrastructures so that they protect data privacy, preserve intellectual assets and offer the service provider some level of relief from privacy and data regulations.

In some literature, a dataflow is called a (data) pipeline (perhaps because sections of a pipeline may initiate a task before other sections of the pipeline have completed their tasks).

In one particular aspect of the systems and techniques described herein, new primitive pipeline elements are presented which may be combined in a variety of ways to transform existing data pipelines into pipelines that are secure, which, roughly speaking, do not leak data or program code and do not reveal any information including the results of any computations to the operator of the pipeline. The secure pipeline primitives may also be used to design new data pipelines that are secure. Thereby, service providers may transform their existing service offerings or design new service offerings that are secure against leaks, invasions of privacy and in which the service providers can conveniently satisfy privacy regulations.

To achieve such transformations of existing dataflows i.e., pipelines, or to design new pipelines that provide such guarantees of security, we define a new notion of computing called oblivious computing wherein the service provider (or, equivalently the operator) offers a service but remains unaware, i.e., is oblivious, to all its components (dataset, algorithm, platform) comprising the computation that engenders the service. (The term oblivious computing is inspired by Rabin's Oblivious Transfer protocol in which the user receives exactly one database element without the server knowing which element was queried, and without the user knowing which other elements of the database were queried. See cf. M. Rabin: “How to Exchange Secrets by Oblivious Transfer,” TR-81, Aiken Computation Laboratory, Harvard University, 1981.) Furthermore, the operator may demonstrate its lack of knowledge of the computation via verifiable proofs generated by the computation itself. Additionally, the proofs may be used to establish that no components of the computation (data or algorithm) were leaked during the computation.

Since no data or aspects of the algorithm were leaked and since the operator is provably oblivious, the computation in question is performed by a (cluster of) computers whose components may not be revealed to any person, including the operator. Any result of the computation may be encrypted and made available only via possession of a decryption key, access to which may be controlled by using a key vault. Thus, only authorized personnel may have access to the results. In a certain sense, the computer itself knows but is unable to reveal the components of the computation.

User Computing Devices

The term user computing device as used herein refers to a broad and general class of devices used by consumers, which have one or more processors and generally have wired and/or wireless connectivity to one or more communication networks such as the Internet. Examples of user computing device include, but are not limited, to smart phones, personal digital assistants, laptops, desktops, tablet computers, IoT (Internet of Things) devices such as smart thermostats and doorbells, digital (surveillance) cameras, etc. The term user computing device also includes devices that are able to communicate over one or more networks using a communication link (e.g., a short-range communication link such as Bluetooth) to another user computing device, which in turn is itself is able to communicate over a network. Examples of such devices include, smart watches, fitness bracelets, consumer health monitoring devices, environment monitoring devices, home monitoring devices such as smart thermostats, smart light bulbs, smart locks, smart home appliances, etc.

Trusted and Isolated Computing Environments

Given the prevalent situation of frequent malicious attacks on computing machinery, there is concern that a computer program may be hijacked by malicious entities. A salient question is whether a program's computer code can be secured against attacks by unauthorized and malicious entities and hence can be trusted?

One possibility is for an enterprise to develop a potential algorithm that is made publicly accessible so that it may be analyzed, updated, edited and improved upon by the developer community. After some time during which this process has been used, the algorithm can be “expected” to be reasonably safe against intrusive attacks, i.e., it garners some trust from the user community. As one learns more from the experiences of the developers, one can continue to increase one's trust in the algorithm. However, complete trust in such an algorithm can never be reached for any number of reasons, e.g., nefarious actors may simply be waiting for a more opportune time to strike.

It should be noted that Bitcoin, Ethereum and certain other cryptocurrencies, and some open-source enterprises use certain methods of gaining the community's trust by making their source code available on public sites. Any person may then download the software so displayed and, e.g., become a “miner,” i.e., a member of a group that makes processing decisions based on the consensus of a majority of the group.

Co-pending U.S. patent application Ser. No. 17/094,118 entitled “Method and System for Enhancing the Integrity of Computing with Shared Data and Algorithms,” which is incorporated by reference herein in its entirety, proposes a different method of gaining trust. As discussed therein, a computation is a term describing the execution of a computer algorithm on one or more datasets. (In contrast, an algorithm or dataset that is simply stored, e.g., on a storage medium such as a disk, does not constitute a computation.) The term process is used in the literature on operating systems to denote the state of a computation and we use the term, process, to mean the same herein. A computing environment is a term for a process created by software contained within the supervisory programs, e.g., the operating system of the computer (or a computing cluster), that is configured to represent and capture the state of computations, i.e., the execution of algorithms on data, and provide the resulting outputs to recipients as per its configured logic. The software logic that creates computing environments (processes) may utilize the services provided by certain hardware elements of the underlying computer (or cluster of computers).

U.S. patent application Ser. No. 17/094,118 creates computing environments which are guaranteed to be isolated and trusted. As explained below, an isolated computing environment is an environment that supports a fixed or maximum number of application processes and specified system processes. A trusted computing environment is an environment in which the digest of the code running in the environment has been verified against a baseline digest.

In particular, we may use (cryptographic) hash functions to create technology that can be used to create computing environments that can be trusted. One way to achieve trust in a computing environment is by allowing the code running in an environment to be verified by using cryptographic hash functions/digests.

That is, a computing environment is created by the supervisory programs which are invoked by commands in the boot logic of a computer at boot time which then use the hash function, e.g., SHA-256 (available from the U.S. National Institute of Standards and Technology), to take a digest of the created computing environment. This digest may then be provided to an escrow service to be used as a baseline for future comparisons.

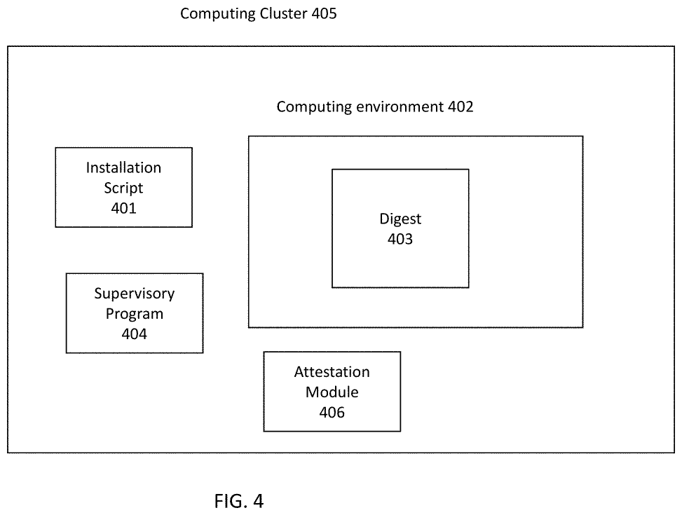

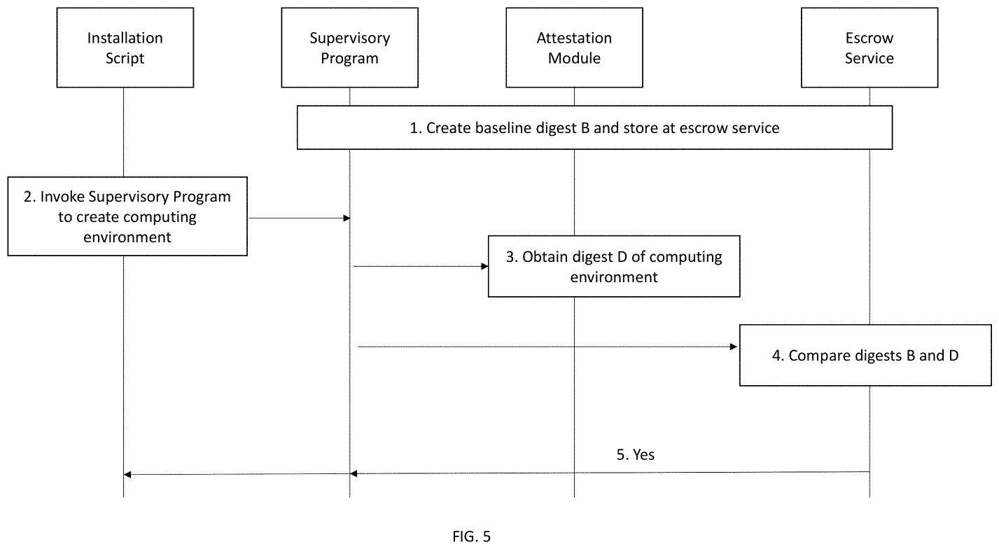

FIG. 4 shows an arrangement by which a computing environment 402 created in a computing cluster 405 can be trusted using the attestation module 406 and supervisory programs 404. As used herein, a computing cluster may refer to a single computer, a group of networked computers or computers that otherwise communicate and interact with one another, and/or a group of virtual machines. That is, a computing cluster refers to any combination and arrangement of computing entities.

FIG. 5 shows an example of method for trusting the computing environment 402.

Method: Attest a computing environment
Input: Supervisory program 404 of a computer 405 provisioned with attestation module 406, installation script 401.
   Output: “Yes” if computing environment 402 can be trusted, otherwise “No.”

Referring now to FIG. 5, the method proceeds as follow:
1. Provisioning step: Boot the computer. Boot logic is configured to invoke attestation method. Digest is obtained and stored at escrow service as “baseline digest, B.”
2. Initiate installation script which requests supervisory programs to create computing environment.
3. Logic of computing environment requests Attestation Module to obtain a digest D (e.g., digest 403 in FIG. 4) of the created computing environment.
4. Logic of computing environment requests escrow service to compare the digest D against the baseline digest, B.
5. Escrow service reports “Yes” or “No” accordingly to the logic of the computing environment which, in turn, informs the installation script.

Note that the installation script is an application-level computer program. Any application program may request the supervisory programs to create a computing environment which then use the above method to verify if the created environment can be trusted. Boot logic of the computer may also be configured, as described above, to request the supervisory programs to create a computing environment.

Whereas the above process can be used to trust a computing environment created on a computer, we may in certain cases require that the underlying computer must be trusted as well. That is, can we trust that the computer was booted securely and that its state at any given time as presented by the contents of its internal memory registers can be trusted.

The attestation method may be further enhanced to read the various PCRs (Platform Configuration Registers) and take a digest of their contents. In practice, we may concatenate the digest obtained from the PCRs with that obtained from a computing environment and use that as a baseline for ensuring trust in the boot software and the software running in the computing environment. In such cases, the attestation process which has been upgraded to include PCR attestation may be referred to as a measurement. Accordingly, in the examples presented below, all references to obtaining a digest of a computing environment are intended to refer to obtaining a measurement of the computing environment in alternative embodiments.

Note that a successful measurement of a computer implies that the underlying supervisory program has been securely booted and its state and that of the computer as represented by data in the various PCR registers is the same as the original state, which is assumed to be valid since we may assume that the underlying computer(s) are free of intrusion at time of manufacturing. Different manufacturers provide facilities that can be utilized by the Attestation Module to access the PCR registers. For example, some manufactures provide a hardware module called TPM (Trusted Platform Module) that can be queried to obtain data from PCR registers.

As mentioned above, U.S. patent application Ser. No. 17/094,118 also creates computing environments which are guaranteed to be isolated in addition to being trusted. The notion of isolation is useful to eliminate the possibility that an unknown and/or unauthorized process may be “snooping” while an algorithm is running in memory. That is, a concurrently running process may be “stealing” data or effecting the logic of the program running inside the computing environment. An isolated computing environment can prevent this situation from occurring by using memory elements in which only one or more authorized (system and application) processes may be concurrently executed.

The manner in which isolation is accomplished depends on the type of process that is involved. As a general matter there are two types of processes that may be considered: system and application processes. An isolated computing environment may thus be defined as any computing environment in which a specified maximum number of application processes and specified system processes implementing the computing environment are able to operate. System processes are allowed access to an isolated memory segment if they provide the necessary keys. For example, Intel Software Guard Extension (SGX) technology uses hardware/firmware assistance to provide the necessary keys. Application processes also allowed entry to an isolated memory segment based on keys controlled by hardware/firmware/software element called the Access Control Module, ACM (described later).

Typically, system processes needed to create a computing environment are known a priori to the supervisory program and can be configured to ask and be permitted to access isolated memory segments. Only these specific system processes can then be allowed to run in an isolated memory segment. In the case of application processes such knowledge may not be known a priori. In this case, developers may be allowed to specify the keys that an application process needs to gain entry to a memory segment. Additionally, a maximum number of application processes may be specified that can be allowed concurrent access to an isolated memory segment.

Computing environments are created by computer code available to supervisory programs of a computing cluster. This code may control which specific system processes are allowed to run in an isolated memory segment. On the other hand, as previously mentioned, access control of application processes is maintained by Access Control Modules.

It is important to highlight the difference between trusted and isolated computing environments. An isolated computing environment is an environment that supports a fixed or maximum number of application processes and specified system processes. A trusted computing environment is an environment in which the digest of the code running in the environment has been verified against a baseline digest.

As an example of the use of isolated memory as an enabling technology, consider the creation of a computing environment as discussed above. The computing environment needs to be configured to permit a maximum number of (application) processes for concurrent execution. To satisfy this requirement, SGX or SEV technologies can be used to enforce isolation. For example, in the Intel SGX technology, a hardware module holds cryptographic keys that are used to control access by system processes to the isolated memory. Any application process requesting access to the isolated memory is required to present the keys needed by the Access Control Module. In SEV and other such environments, the supervisory program locks down the isolated memory and allows only a fixed or maximum number of application processes to execute concurrently.

Consider a computer with an operating system that can support multiple virtual machines (VMs). (An example of such an operating system is known as the Hypervisor or Virtual Machine Monitor, VMM.) The hypervisor allows one VM at a given instant to be resident in memory and have access to the processor(s) of the computer. Working as in conventional time sharing, VMs are swapped in and out, thus achieving temporal isolation.

Therefore, to achieve an isolated environment, a hypervisor like operating system may be used to temporally isolate the VMs and, further, allow only specific system and a known (or maximum) number of application processes to run in a given VM.

As previously mentioned, U.S. patent application Ser. No. 17/094,118 introduced the concept of Access Control Modules (ACM), which allow application processes entry to an isolated memory segment based on keys controlled by hardware/firmware/software element called the Access Control Module (ACM). ACMs are hardware/firmware/software components that use public/private cryptographic key technology to control access. An entity wishing to gain access to a computing environment must provide the needed keys. If it does not possess the keys, it will need to generate the keys to gain access which will require it to solve the intractable problem corresponding to the encryption technology deployed by the ACM, i.e., assumed to be a practical impossibility.

Access to certain regions of memory can also be controlled by software that encrypts the contents of memory that a CPU (Central Processing Unit) needs to load into its registers to execute, i.e., the so-called fetch-execute cycle. The CPU then needs to be provided the corresponding decryption key before it can execute the data/instructions it had fetched from memory. Such keys may then be stored in auxiliary hardware/firmware modules, e.g., Hardware Security Module (HSM). An HSM may then only allow authorized and authenticated entities to access the stored keys.

It is important to note that though a computing environment may be created by supervisory programs, e.g., operating system software, the latter may not have access to the computing environment. That is, mechanisms controlling access to a computing environment are independent of mechanisms that create said environments.

Thus, the contents of a computing environment may not be available to the supervisory or any other programs in the computing platform. An item may only be known to an entity that deposits it in the computing environment. A digest of an item may be made available outside the computing environment and it is known that digests are computationally irreversible.

Computing environments that have been prepared/created in the above manner can thus be trusted since they can be programmed to not reveal their contents to any party. Data and algorithms resident in such computing environments do not leak. In subsequent discussions, computing environments with this property are referred to as secure (computing) environments.

Oblivious Computations

We now demonstrate methods by which secure computing environments of the type described above may be used to implement oblivious computing procedures. That is, oblivious computing procedures as defined herein are procedures that are performed using secure computing environments in the manner described below. Furthermore, an oblivious procedure is one that is performed using a secure pipeline to execute the steps or tasks in a dataflow. The secure pipeline includes a series of interconnected computational units that are referred to herein as secure pipeline primitives. In some embodiments each secure pipeline primitive is used to perform one step in the dataflow. For instance, in an ETL dataflow, each of the three steps—extract, transform and load—may be performed by a different secure pipeline primitive.

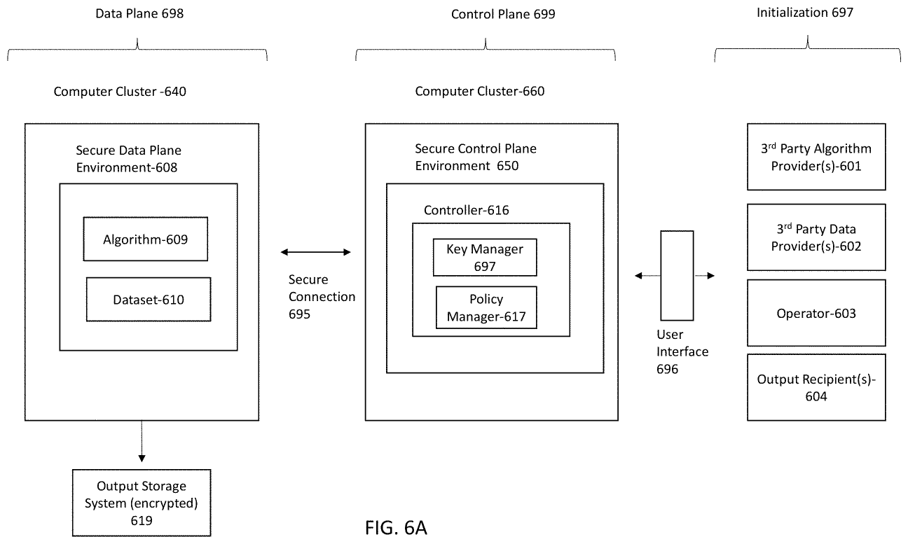

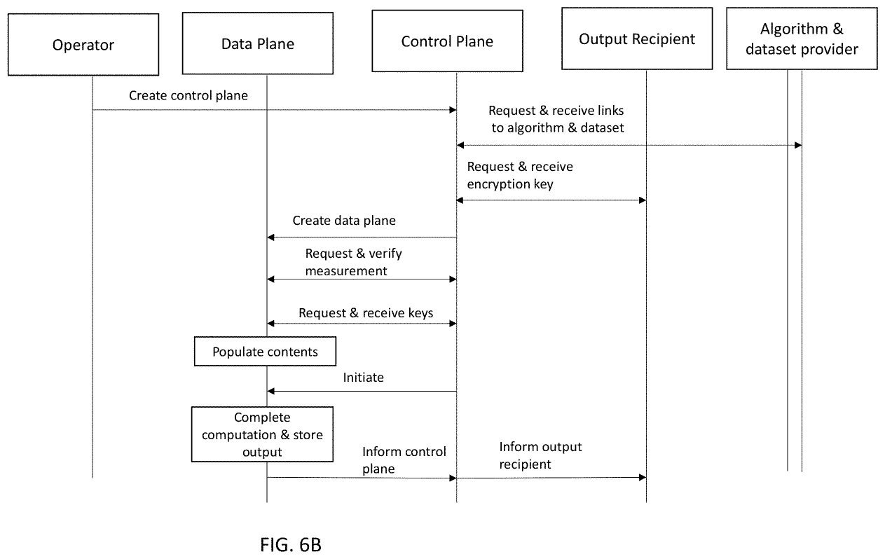

FIG. 6A shows one example of a single secure pipeline primitive, which is based on the secure computing environment described in connection with FIG. 4. As shown in FIG. 6A, two different 3^{rd} party entities wish to contribute material that will be used to perform a computational task. In particular, third party algorithm provider 601 may wish to provide one or more algorithms (e.g., embodied in computer programs) that will be used in the computational task. Likewise, the third party dataset provider 602 may wish to provide the dataset(s) on which the algorithms operate when performing the computational task. (The arrangements between and among the third party entities 601 and 602 as well as the platform operator 603 that provides the pipeline may be achieved by an out-of-band agreement between the various entities.)

We begin by creating a secure control plane environment 650 on a computing cluster 660 using the method described in connection with FIG. 5. (This step may be performed by any entity, including the operator or service provider 603) Secure control plane environment 650 contains a computer program 616 called the Controller. In turn, the Controller 616 contains two sub programs, Key Manager 697 and Policy Manager 617. (Programs 697 and 617 may be thought of as subroutines or more aptly as entry points available to the Controller.) It will be convenient to refer to the entire arrangement implemented on the computing cluster 660 as the control plane 699.

Controller 616 is responsive to user interface 696, which may be utilized by external programs to interact with it. Rather than detail the various commands available in user interface 696, we will describe the commands as they are used in the descriptions below.

In one embodiment, algorithm provider 601 indicates (using e.g., commands of user interface 696) to Controller 616 that it wishes to deposit algorithm 609. Controller 616 requests Key Manager 697 to generate a secret/public cryptographic key pair and provides the public key component to algorithm provider 601. The latter encrypts the link to its algorithm and transmits the encrypted link to Controller 616, which upon receipt deposits the received information in Policy Manager 617.

Additionally, the algorithm provider 601 may optionally use user interface 696 to provide Controller 616 various policy statements that govern/control access to the algorithm. Various such policies are described in the aforementioned U.S. patent application Ser. No. 17/094,118. In the descriptions herein, we assume a policy that specifies that the operator is not allowed access to the algorithm, the dataset, etc. Policy Manager 617 manages the policies provided to it by various entities.

Next, dataset provider 602 follows a similar procedure by which it provides the encrypted link to its dataset 610 to Controller 616 using a different cryptographic public key that is provided to it by the Key Manager 697.

The output produced by the computation carried out by the algorithm(s) on the dataset(s) is to be provided to an output recipient 604, who may be designated, by an out of band agreement, by the entities 601 and/or 602, or by any other suitable means. The output recipient 604 provides an encryption key to Controller 616 to be used to encrypt the result of the computation.

Controller 616 may now invoke supervisory programs to create secure data plane environment 608 (using the method shown in FIG. 5) on computing cluster 640. It should be noted that computing clusters 640 and 660 need not be physically distinct but may share computing entities or may even both reside on a single physical computer. Controller 616 and secure data plane environment 608 communicate via a communication connection 695 using secure communication protocols and technologies such as, for example, Transport Layer Security (TLS) or IPS (Inter-Process Communication), etc.

Controller 616 may now request and receive an attestation/measurement from secure data plane environment 608 to verify that secure data plane environment 608 is secure using the method of FIG. 5. This attestation/measurement, if successful, establishes that secure data plane environment 608 is secure since its code base is the same as the baseline code (which has presumably been placed in escrow). Once verified, Controller 616 may provide secure data plane environment 608 the encrypted links for accessing algorithm 609 and dataset 610. To use the links, secure data plane environment 608 needs to decrypt the respective links. To do this the secure data plane environment 608 requests and receives the secret keys from Controller 616 that allow it to decrypt the respective links and retrieve the algorithm 609 and dataset 610.

Instead of simply providing an encrypted link to unencrypted assets, the, algorithm provider 601 and dataset provider 602 optionally may encrypt its respective assets, i.e., the algorithm 609 and dataset 610. In such a case, third party providers 601 and 602 need to provide the corresponding decryption keys to the Controller 616 which, in turn, must provide the same to the secure data plane environment 608. (Of course, third party providers 601 and 602 need to suitably manage and secure their secret keys used to encrypt their assets.) Secure data plane environment 608 may now decrypt the algorithm 609 and dataset 610. It should be noted that in other implementations the third party providers may encrypt both the assets and the link to those assets, in which case they will need to provide the appropriate decryption keys to Controller 616.

It should be noted that in some cases dataset 610 may be too large to fit in the memory available to secure data plane environment 608. In this case, as is well known to those of ordinary skill, the dataset may be stored in an external storage system (not shown in FIG. 6) and a computer program, usually called a database processor, is used to make retrievals from the storage system over suitably secure communication links.

In some cases Controller 616 optionally may request secure data plane environment 608 to provide a measurement so that its contents (containing the computer code of the secure data plane environment 608, algorithm 608 and dataset 610 (or database processor) may be verified as being secure). This additional measurement, if verified, proves that the algorithm 609 is operating on dataset 610, assuming baseline versions of the algorithm and dataset/database processor are available externally, e.g., through an escrow service.

It will be convenient to refer to the secure data plane environment 608 created on computing cluster 640 as data plane 698.

Controller 616 is now ready to trigger secure data plane environment 608 to begin the computation whose result will be stored in encrypted form in output storage system 619 using the key provided by the output recipient 604. The output recipient 604 may now use its corresponding decryption key to retrieve and view the output results.

We summarize the above steps for creating the secure pipeline primitive of FIG. 6A as follows, which are also shown in the message flow diagram of FIG. 6B.
Operator creates control plane 699 (containing Controller 616).
Control plane 699 requests and receives links for algorithm, dataset and encryption (public) key designated by output recipient.
Control Plane 699 creates secure data plane environment 608 (data plane 698).
Data plane 698 requests and receives various keys that enable it to acquire algorithm 609, dataset 610 and encryption key to be used to encrypt the output of the computation.
Control plane 699 triggers data plane 698 to initiate computation.
Data plane 698 stores encrypted result of computation in storage system 619 and informs control plane.
Control plane 699 informs output recipient 604 that the output is ready to be retrieved.

As a parenthetical note, we use the term storage system in a generic sense. In practice, a file system, a data bucket, a database system, a data warehouse, a data lake, live data streams or data queues, etc., which may be used to effectuate the input and output of data.

We note that in the entire process outlined and detailed above for creating a secure pipeline primitive and for performing a computation in that environment, the operator 603 never comes into possession of the secret keys generated and stored within Controller 616 or in possession of the output recipient 604. Thus, the operator is unable to access the code of the secure data plane environment 608, algorithm 609, the dataset 610 or the output 619. That is, the computation is an oblivious computation. This same property will be applicable to computations performed in the secure pipelines described below, which include a series of secure pipeline primitives of the type shown in FIG. 6A.

Oblivious Pipelines

In the descriptions so far, we have considered a data plane containing a single secure (computing) environment. In general, the control plane may create multiple secure environments and configure them to be inter-connected in a variety of ways by suitably connecting their input and output storage systems. That is, the description so far has considered a single secure pipeline primitive, which may serve as the basis for a larger secure pipeline made up of a series of secure pipeline primitives that each perform one or more distinct steps in a dataflow.

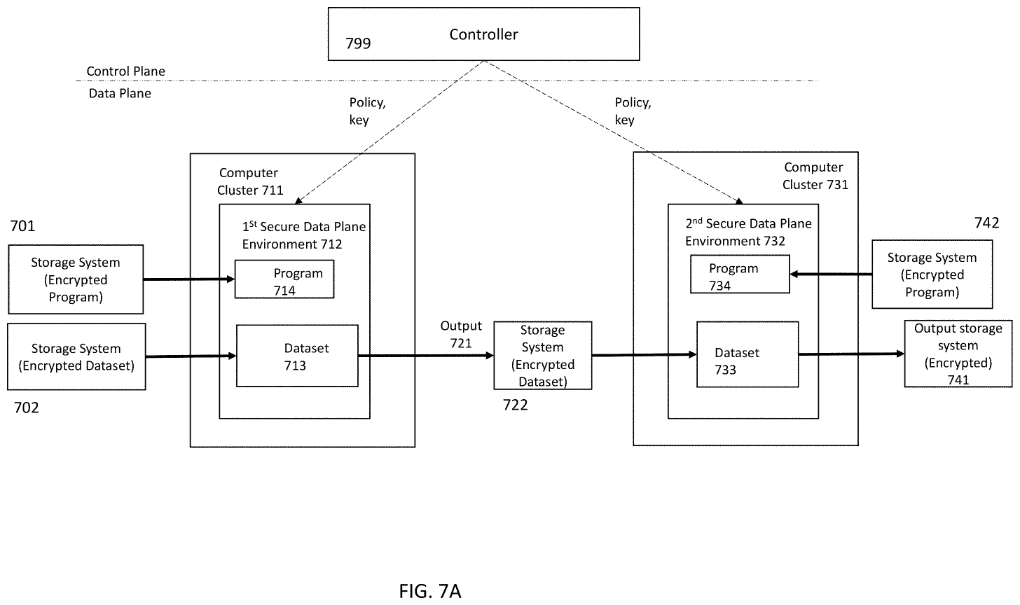

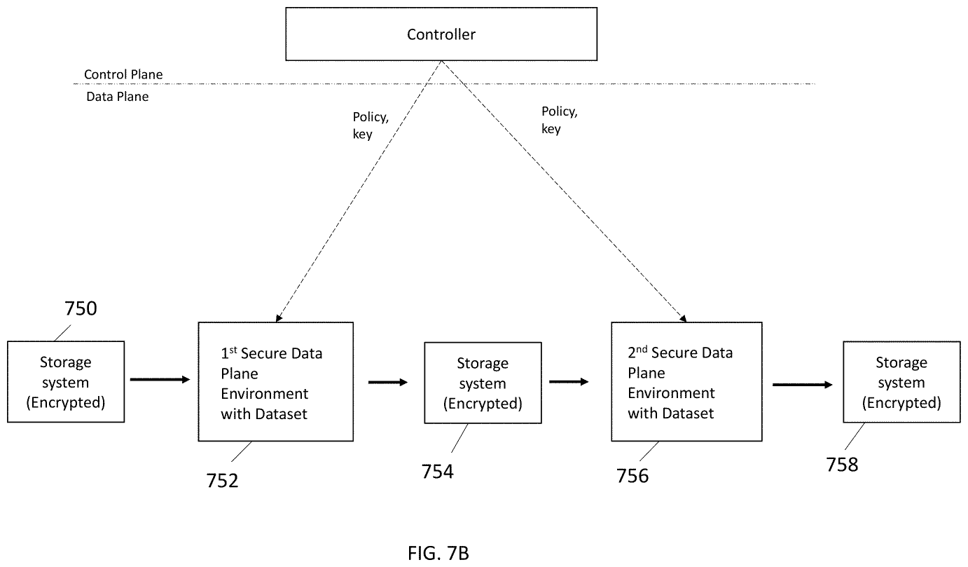

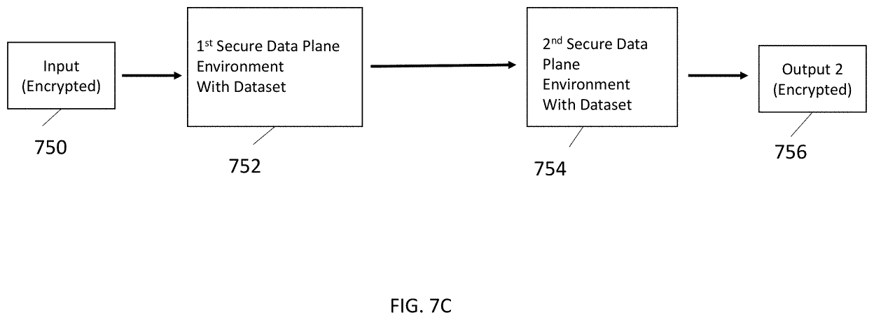

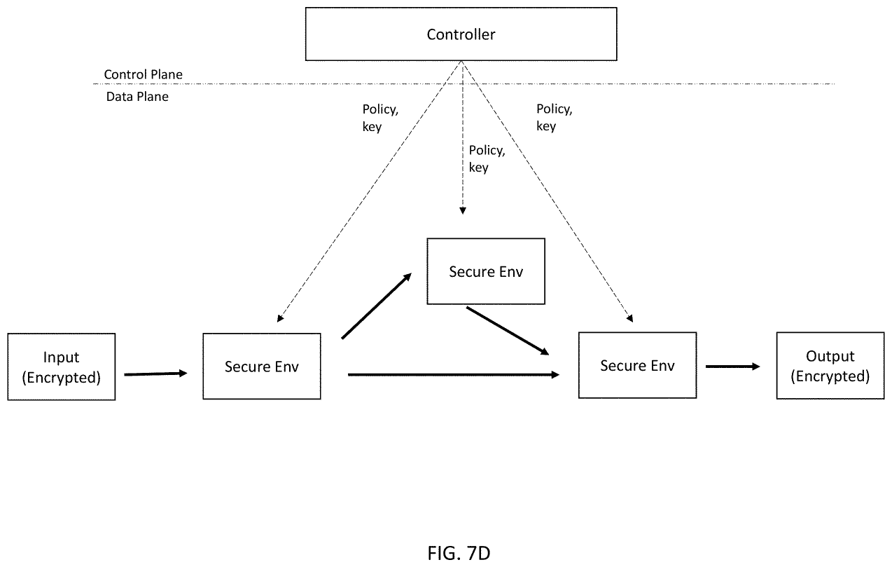

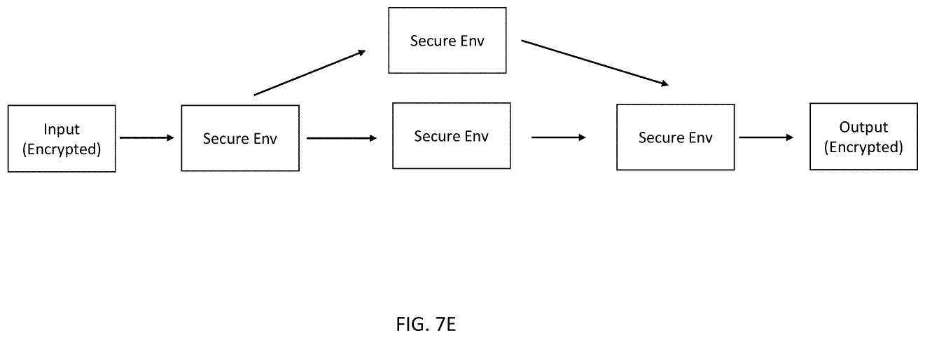

FIG. 7A shows an arrangement in which control plane 799 creates a data plane comprising two secure data plane environments 712 and 732. We do not show the algorithm and dataset providers for the sake of simplicity. Rather, we show the algorithm/computer program 714 that is to be provided to a first secure data plane environment 712 via storage system 701 and algorithm/computer program 734 that is to be provided to a second secure data plane environment 732 via storage system 742. Similarly, the dataset 713 is provided by storage system 702 to the first secure data plane environment 712 and dataset 733 is provided by storage system 722 to the second secure data plane environment 732.

Thus, the output of storage system 702 provides input to the first secure data plane environment 712 in the form of a dataset 713 and the output of the first secure data plane environment 712 is provided to output storage system 722. In turn, output storage system 722 serves as input to the second secure data plane environment 732 and the output of the second secure data plane environment 732 is provided to output storage system 741. As noted above, we refer to this simplified arrangement as a secure data pipeline or simply a secure pipeline. In this example the secure pipeline consists of two secure pipeline primitives. Note that since secure pipelines satisfy the oblivious requirement they may also be referred to as oblivious pipelines.

FIG. 7B shows a simplified representation of the secure pipeline depicted in FIG. 7A, which will be useful in the following discussion and which better emphasizes the usage of the term pipeline. Note that we have obtained FIG. 7B by eliminating the details of the computer clusters, the details of the control plane and the algorithms/computer programs, and instead concentrate on the datasets and secure data plane environments. As in the example of FIG. 7A, this example consists of two secure pipeline primitives. The first secure pipeline primitive includes the first secure data plane environment 752, which obtains its dataset from storage system 750. The first secure pipeline primitive also includes the storage system 754, which stores the output that results from the computation performed in the first secure data plane environment 752. Likewise, the second secure pipeline primitive includes the second secure data plane environment 756, which obtains its dataset from storage system 754. That is, the input to the second secure data plane environment 756 is the output from the first secure data plane environment 752. The second secure pipeline primitive also includes the storage system 758, which stores the output that results from the computation performed in the second secure data plane environment 756.

It should be noted the simplified representation of a secure pipeline as shown in FIG. 7B only depicts the dataflow in the pipelines. As noted above, various other components of the individual pipeline primitives that make up the secure pipeline are not shown in FIG. 7B. Rather, these details are shown in FIGS. 6A and 7A. In particular, it should be noted that each individual secure data plane environment (e.g., first and second data plane environments 752 and 756 in the example of FIG. 7B) are assumed to be able to access and execute the various algorithms/computer programs from the various third party providers, which are used to perform the computations on the dataset as it proceeds through the pipeline.

A further simplification of the pipeline representation shown in FIG. 7B (and the analogy to pipelines further strengthened) may be achieved as shown in FIG. 7C, where we do not show the control plane and the intermediate storage systems that serve to transfer the output dataset from one secure data plane environments to another data plane environment.

Whereas FIGS. 7A, 7B and 7C show secure pipelines with two secure pipeline primitives, pipelines may comprise of any number of primitives that may be inter-connected. The inter-connection topology, in general, may be a directed acyclic graph (DAG) as shown in FIG. 7D with a control plane and FIG. 7E that shows the DAG of FIG. 7D without the control plane. Note that in these figures the various intermediate pipeline primitives are simply represented by their secure data plane environments, which may be thought of as nodes in the overall secure pipeline topology.

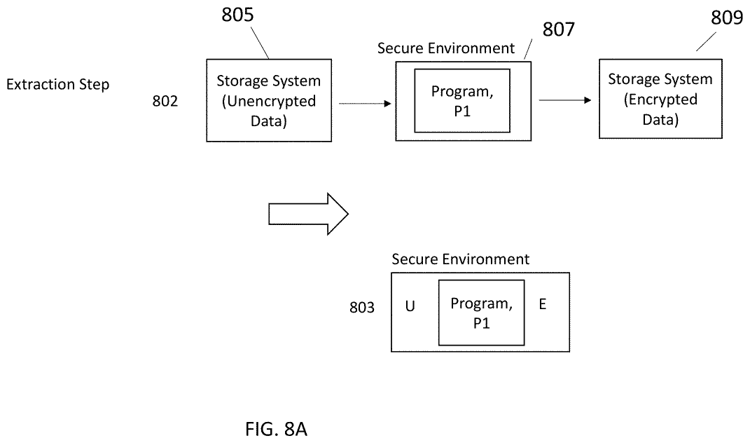

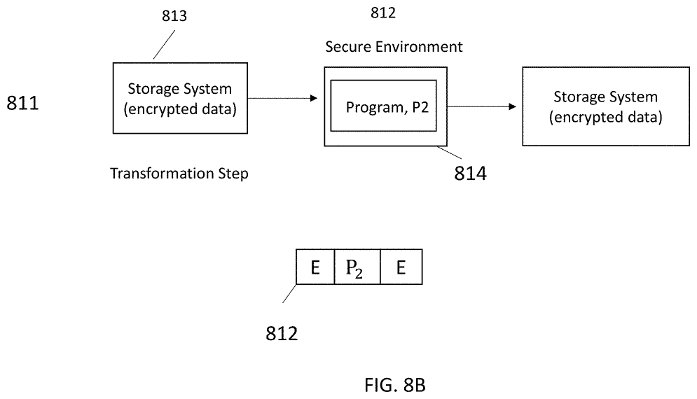

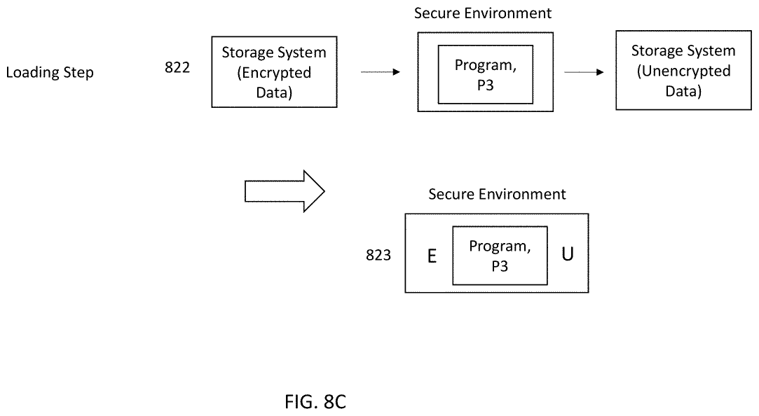

The simplified representations of pipelines introduced above in FIGS. 7B-7D may be used to depict the implementation of ETL, ELT and TEL dataflows using secure data pipelines. This depiction will be illustrated in connection with FIGS. 8A, 8B and 8C.

FIG. 8A shows a simplified representation 802 of the extraction step of a secure pipeline. As shown, unencrypted data in storage system 805 is processed in secure data plane environment 807 by a program P1, which extracts and encrypts the data and stores it in storage system 809. The simplified representation 802 may be further simplified as shown in the representation 803. Note that the symbol “U” in 803 denotes that the input to program P1 is unencrypted and the symbol “E” denotes that P3 produces encrypted output.

Similar to the representations in FIG. 8A, FIG. 8B shows a simplified representation 811 of the transformation step of a secure pipeline. As shown, encrypted data in storage system 813 is processed in secure data plane environment 814 by a program P2, which decrypts the data, processes the data, the re-encrypts it and stores it in storage system 815 The simplified representation 811 may be further simplified as shown in the representation 812.

FIG. 8C shows a simplified representation 822 of the loading step of a secure pipeline whose simplified form is shown in 823. Note that the symbol “E” in 823 denotes that the input to program P3 is encrypted and the symbol “U” denotes that P3 produces unencrypted output.

Existing ETL, ELT and TEL pipelines may be transformed into a sequence of secure pipeline primitives using the above-described secure pipeline primitives. In general, the primitives may also be used to construct secure pipelines anew. We note further that the various primitives described above, ipso facto, satisfy the oblivious property.

### Various Embodiments

We now show various illustrative embodiments of different use cases that can employ secure pipelines as described herein. As will be evident from these examples the various secure pipeline primitives described above may be combined to produce new service offerings or to transform existing service offerings.

Crowd Sourced Data Applications

Many user computing devices collect data that is provided to apps for processing. In some cases, the processing may be partly performed on the user computing device itself and partly by another app, e.g., in a cloud-based server arrangement. For instance, digital camera devices capture facial, traffic and other images which may then be processed to identify consumers, members of the public wanted by the police, etc. Similarly, images of automobiles may be used to identify those that violate traffic regulations. In healthcare applications, wearable devices, smart phones and devices connected to or associated with smart phones collect data from consumers concerning their health (e.g., level of activity, pulse, pulse oximeter data, etc.). In some cases, collected data is analyzed and/or monitored, and consumer-specific information in the form of advice or recommendations is communicated back to the consumer. Consumer activity may be monitored and general recommendations for fitness goals etc. may be transmitted to consumers. In some cases, the behavior of the client app may be modified on the basis of analyzing collected data. A general name for such services offerings is crowd sourced data (CSD) applications.

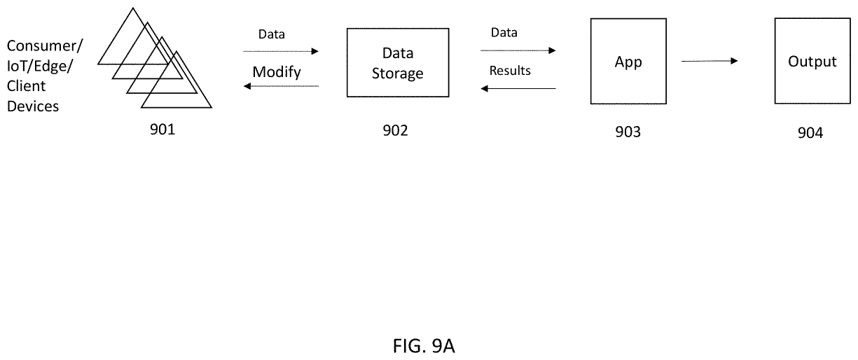

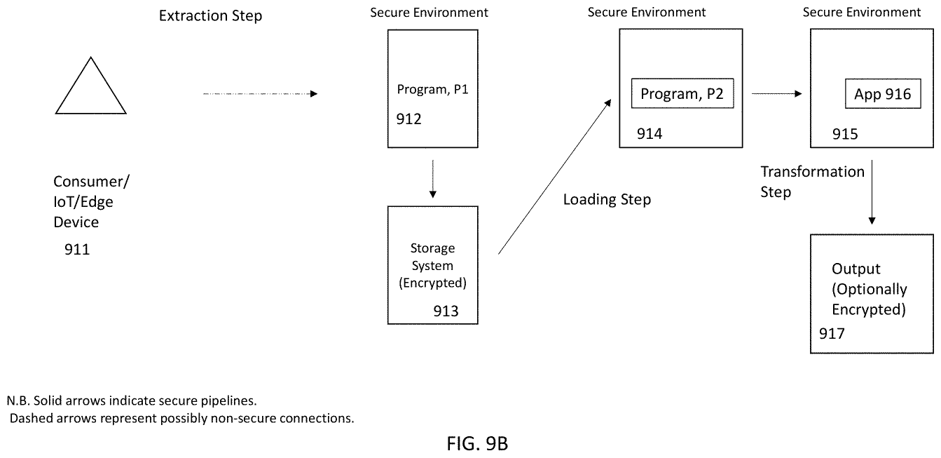

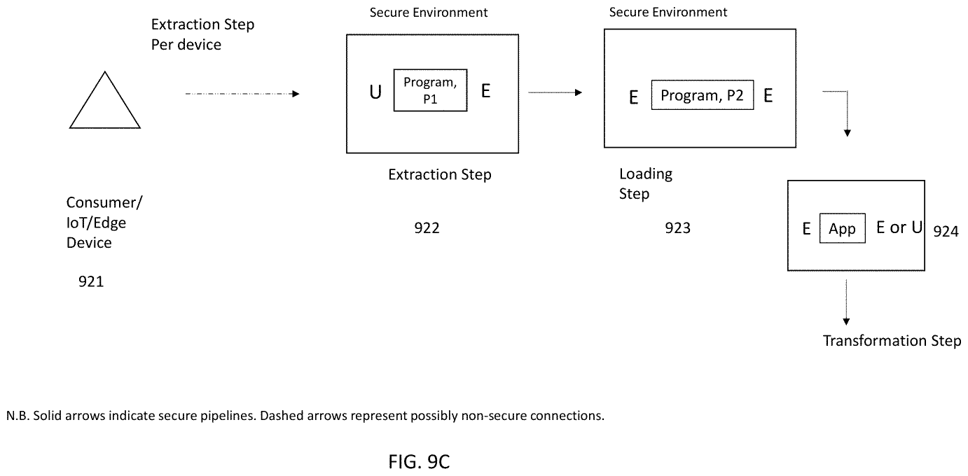

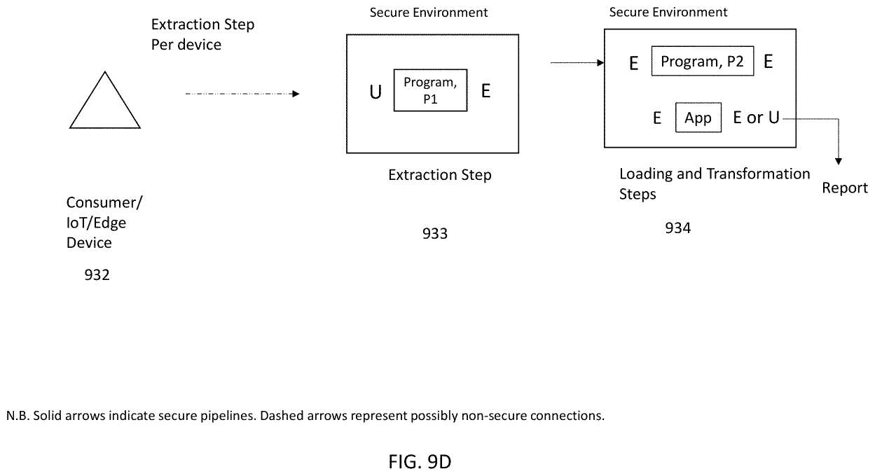

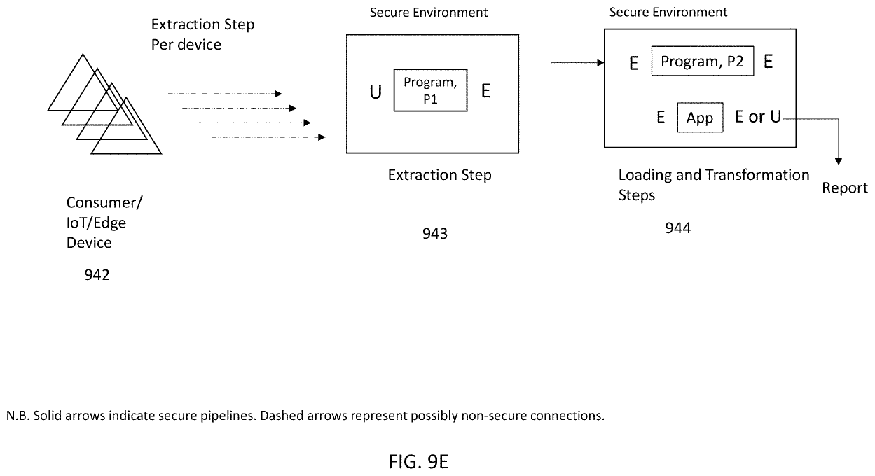

FIG. 9A shows a data flow for typical service offering concerning CSD applications. Not unexpectedly given the scale of the offering in terms of the potentially large number of consumer devices that may be involved, a dataflow architecture is often used in which user computing devices 901 (often containing a computer program e.g., a client app, that may have been downloaded from a well-known website) generate data and provide it to data storage system 902. For illustrative purposes only, without loss of generality, one example of a computer program that presented in some cases in FIG. 9 and the figures that follow is referred to as application software (“app”).

In some embodiments, the user computing devices 901 may contain secure computing environments wherein all or a part of the collected data may be processed. For instance, app 903 may be a computer program (or a collection of computer programs) that process the data in storage system 902. Results of the processing 904 may be provided to the service provider (e.g., meta-data concerning the service offering, audit logs, etc.) as output 904 or saved in data storage 902 for subsequent processing. Additionally, the data in storage system 902 may be processed to provide monitoring and recommendations to the user computing devices 901.

Thus, FIG. 9A actually shows two data pipelines pertaining to each user computing device and terminating at storage system 902. The first pipeline comprises the data emanating from the user computing device (i.e., a member of the device group denoted by reference numeral 901) and terminating at the storage system 902. The second data pipeline starts at storage system 902 and terminates at the user computing device. This second data pipeline may return the results of processing the data by the app to the data storage 902, from which individual ones of the user computing devices can access their own respective portion of the processed data (and not the processed data associated with other users). Alternatively, we may think of the two data pipelines associated with a particular user computing device 901 and to and from storage system 902 as a single bi-directional data pipeline.

FIG. 9B shows how the pipelines of FIG. 9A can be transformed into secure pipelines. For simplicity of illustration, we concentrate on a single user computing device 901 and consider the case of a unidirectional pipeline. In FIG. 9B the pipeline from the user computing device 901 to the data storage 902 (FIG. 9A) can be replaced by a secure extraction pipeline primitive in which a program P1 extracts the data from the user computing device 901 and stores it in the storage system 913 in encrypted form. (pipeline from data storage 902 to app 903 is replaced by the loading pipeline primitive (822 cf. FIG. 8B) using the program P2. Further, the pipeline from app 903 to output 904 (cf. FIG. 9A) is replaced by two transformation pipeline primitives (812 cf. FIG. 8B), represented by a program P2 that performs the loading in secure computing environment 914 and an app 916 or other computer program that performs the transforming in secure computing environment 915.

Similarly, we can depict unidirectional secure pipelines for each edge device in FIG. 8A. We also observe that FIG. 9B can be further simplified by using the terminological convention described above in connection with the simplified representation 803 in FIG. 8A. FIG. 9C shows the resulting simplified secure pipeline. Note, as explained earlier, that the symbols “U” and “E” denote “unencrypted” and “encrypted” input/output data, respectively.

Note the secure pipeline shown in FIG. 9C is of type ELT. Also note that pipeline primitives 923 and 924 can be combined into a single pipeline primitive 934 as shown in FIG. 9D. In computational terms, pipeline primitive 934 requires that the corresponding secure computing environment needs to run program P2 and the App with the indicated encrypted inputs and outputs. That is, FIG. 9D shows a possibly more efficient implementation of the pipeline of FIG. 9C since it uses one less secure computing environment.

We may summarize the secure pipeline transformation of FIG. 9A as shown in FIG. 9E wherein a number of (non-secure) pipelines emanating from edge devices converge at pipeline primitive 943 from whence the data is processed by program P1 and further provided to pipeline primitive 944. Upon further processing at pipeline primitive 944 by program P2 and App, the pipeline generates an output.

### Data Intensive Applications

Machine Learning (ML) and Big Data applications are known as data intensive applications because they depend critically on copious amounts of input data. The learning capability of ML systems increases in general with the amount of training data provided to it. There is a burgeoning area of data monetization wherein enterprises acquire datasets to train ML classifiers and other AI programs. Datasets containing medical patient data records are in demand in pharmaceutical and healthcare sectors.

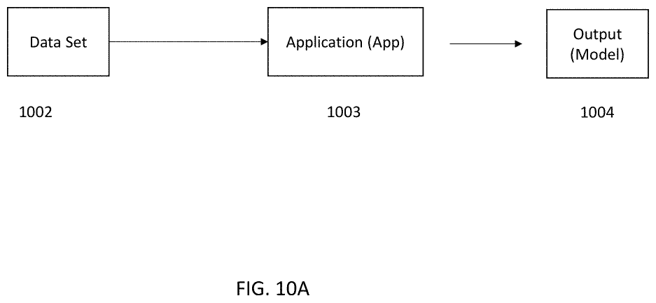

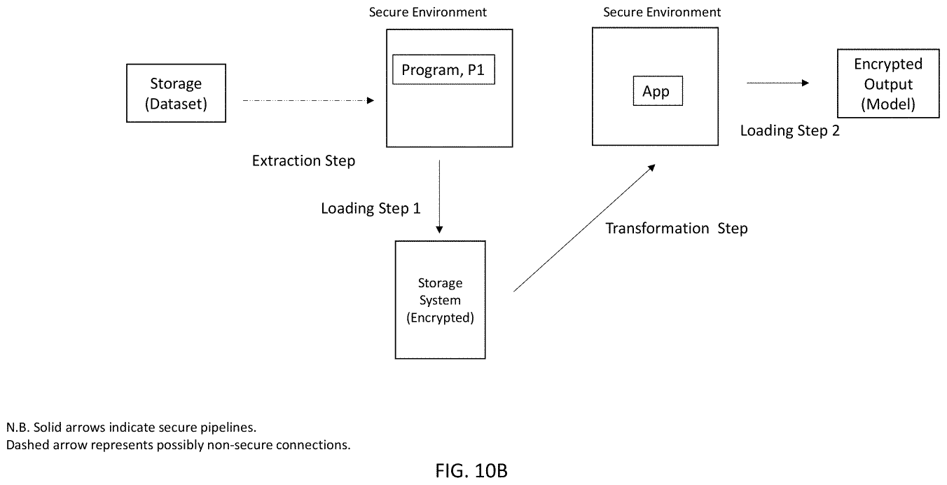

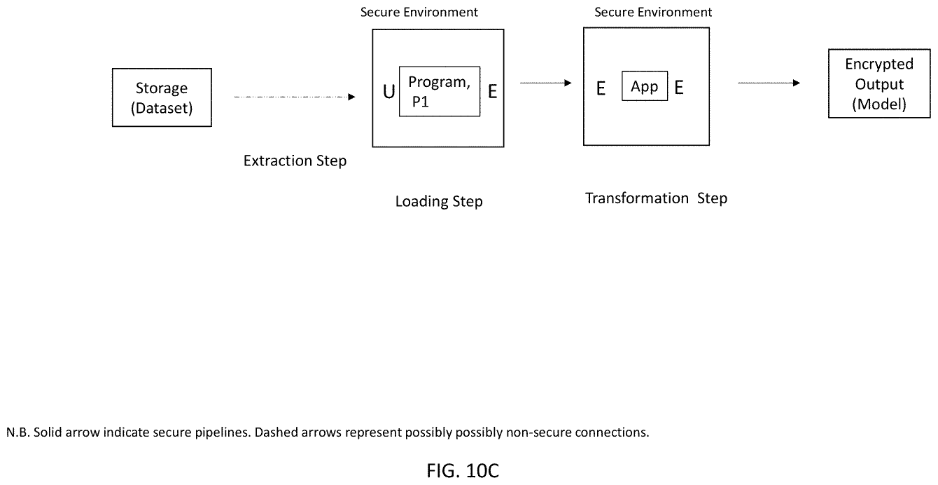

FIG. 10A shows a simple example of a dataset 1002 being provided to a computer program (e.g., app 1003 in this example), which produces a result, i.e., a trained model 1004. The data provider providing dataset 1002 may be concerned that its dataset be only made available to app 1003 and not to any other program. The enforcement of such policy restrictions are discussed in the aforementioned U.S. patent application Ser. No. 17/094,118.

The provider of the dataset 1002 may have further concern of protecting its dataset from the service provider. This may be achieved by using secure pipelines as a service infrastructure. FIGS. 10B and 10C show the corresponding secure pipeline and the simplified pipeline representations.

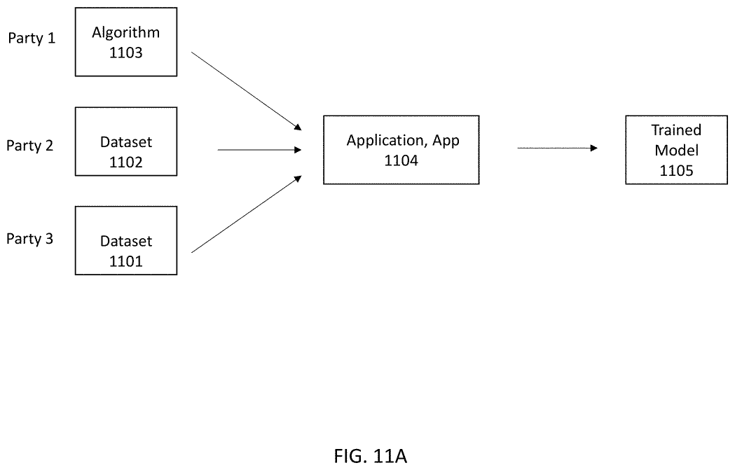

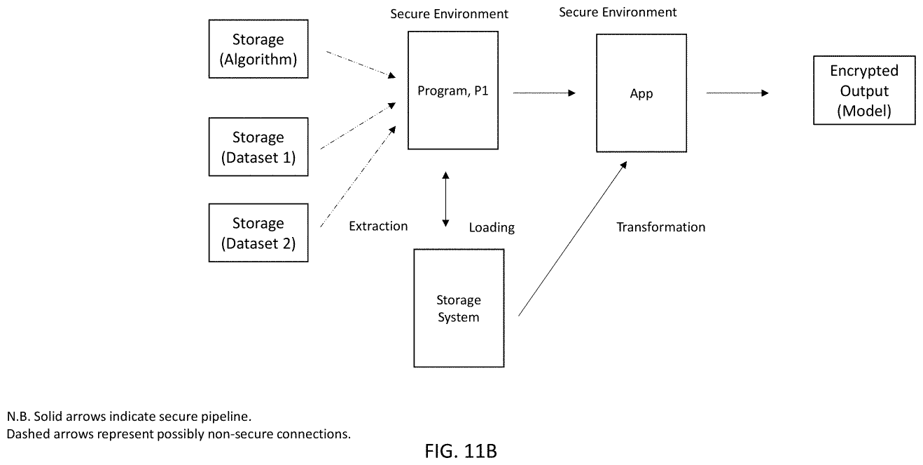

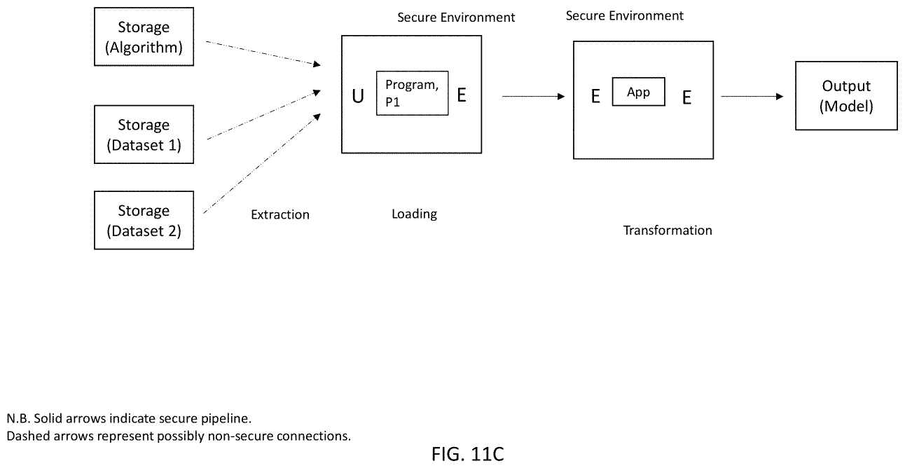

FIG. 11A shows a variation of the above case in which two datasets 1101 and 1102 are made available to algorithm 1103. The datasets and the algorithm are each provided to app 1104 by a different third party. The app 1104 processes the data and outputs a trained model 1105. The corresponding secure pipeline infrastructure is shown in FIG. 11B and its simplified representation in FIG. 11C. In this case program P1 is used to perform a loading step in a secure environment and the processing performed by the app in another secure environment corresponds to the transforming step shown in FIGS. 11B and 11C.

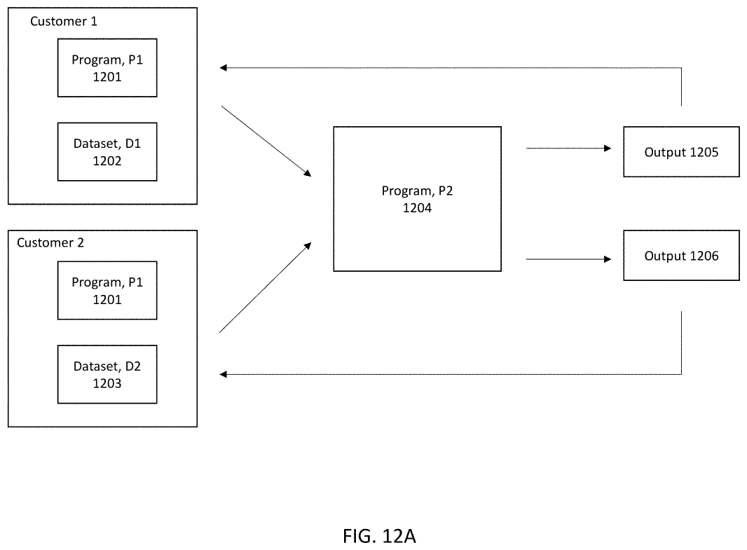

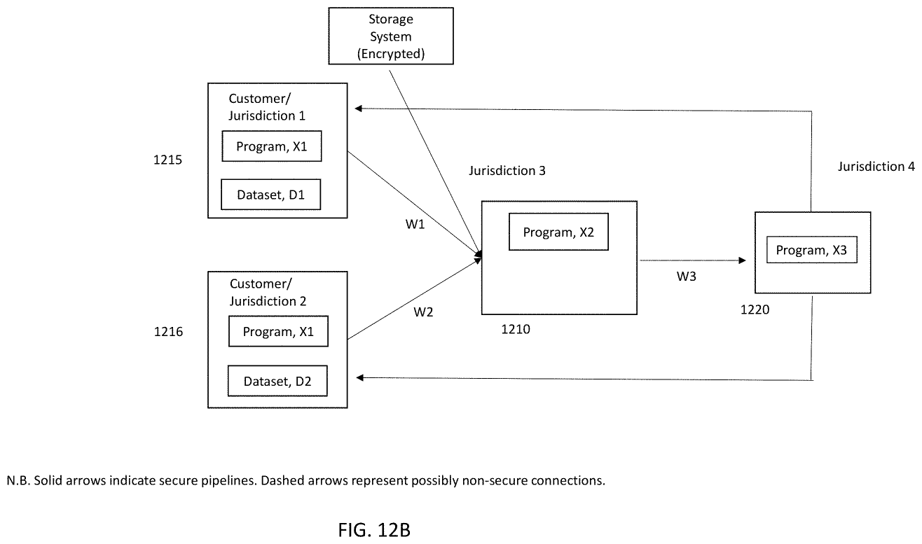

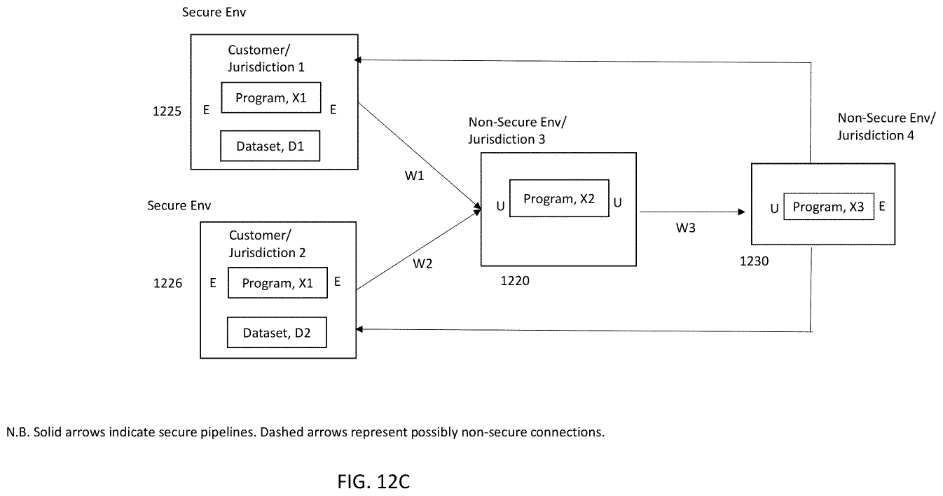

FIG. 12A shows yet another variation of a data intensive application. FIG. 12A shows a “gedanken” process in which program P1 (1201) is provided to customers 1 and 2 who use P1 to send datasets D1 and D2, respectively, to computing environment 1204 where they are processed by program P2. The latter then produces two outputs 1205 and 1206 which are sent to customers 1 and 2, respectively.

A practical example of this use case involves restrictions in moving the datasets 1202 and 1203 (containing, e.g., customer records) across jurisdictional boundaries or due to concerns of security. For example, many banks have different branches in different countries and data residency regulations prevent datasets being sent across jurisdictional boundaries. However, the need to process and match the two different datasets arises, for example, in anti-money laundering processes, wherein one needs to combine different datasets to find common individuals or patterns. The gedanken arrangement of FIG. 12A may thus violate data residency regulations since it proposes moving the datasets 1202 and 1203 to a third jurisdiction.

FIG. 12B proposes a different gedanken experiment using Deep Learning Neural Network (DLNN) programs X1, X2 and X3. Program X1 is provided to customer 1 (in a jurisdiction 1, for example) where it processes dataset D1. Program X1 is also provided to customer 2 in jurisdiction 2 where it processes dataset D2. (Note that D1 and D2 are the same datasets as 1202 and 1203, respectively, in FIG. 12A.) As is well-known in DLNN type of programs, the learnings (results) obtained from the processing are contained in the internal weights of the respective programs. Thus program X1 in jurisdiction 1 after processing dataset D1 contains its learnings in its internal weights W1. Similarly, program X1 after running on dataset D2 in jurisdiction 2 contains its learnings in its internal weights W2.

We may now send the learnt internal weights W1 and W2 from jurisdiction 1 (1215) and 2 (1216) to a new jurisdiction, say jurisdiction 3 having computing environment 1210, where they may be processed by a DLNN program X2. Since the weights of DLNN programs are known to simply be numbers (integers or reals), sending them across jurisdictions generally will be non-violative of data residency regulations. (Program X1 in practice may encode customer/jurisdiction identity information in the form of anonymity-preserving identification numbers which may accompany the weight matrices W1 and W2.)

Program X2 running in computing environment 1210 may then obtain new learnings by combining the weights matrices W1 and W2 and associate the new learnings with customers/jurisdictions identified by anonymity-preserving identification numbers. The combined new weight matrix, W3, may now be provided as input to a program, X3 operating in a computing environment 1220 residing in jurisdiction 4, which sorts the learnings by customer/jurisdiction and returns the learnt findings to customer jurisdictions 1 and 2.

FIG. 12C shows a secure pipeline implementation of the processes shown in FIG. 12B in which the computing environments are now secure computing environments. Since jurisdictions 1 and 2 process customer specific information in secure computing environments 1225 and 1226 need to secure pipelines that receive and output encrypted (E) information. Since the weights W1 and W2 and other information incident to 1220 is anonymity-preserving, computing environment 1220 need not be necessarily a secure pipeline. It may thus receive and output unencrypted data. Computing environment 1230 receives unencrypted data but, since it needs to provide input to secure pipelines, outputs encrypted information to secure computing environments 1225 and 1226, respectively.

Note that FIG. 12C serves to show a pipeline that uses both secure and non-secure pipeline primitives to effectuate an overall process.

### Messaging Systems

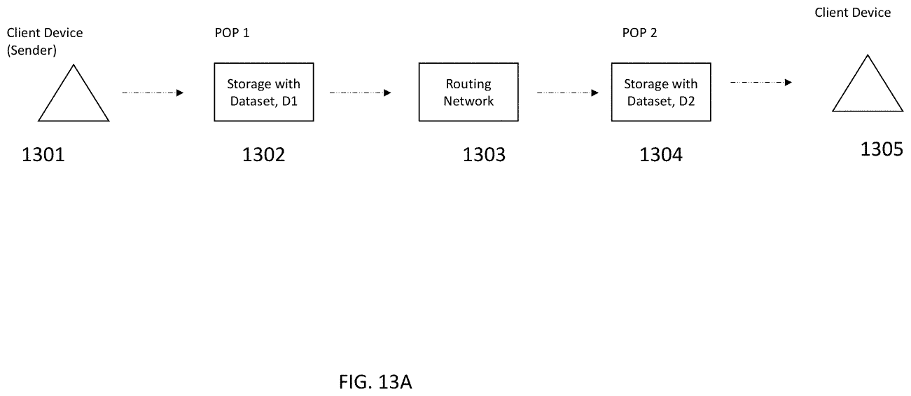

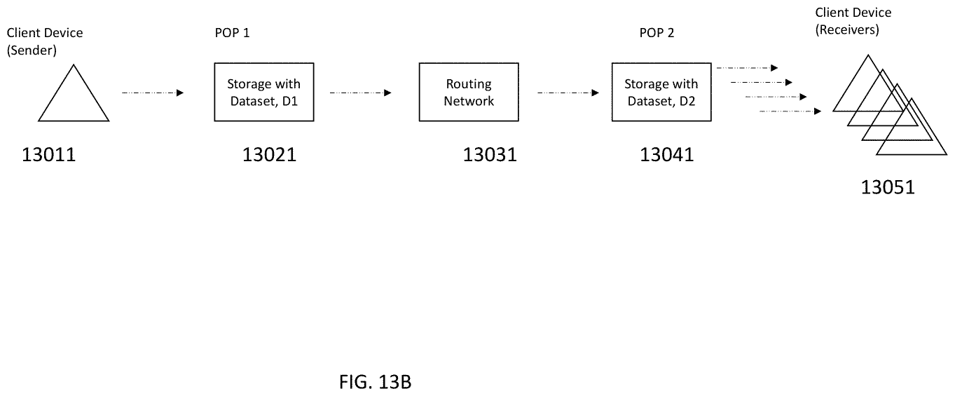

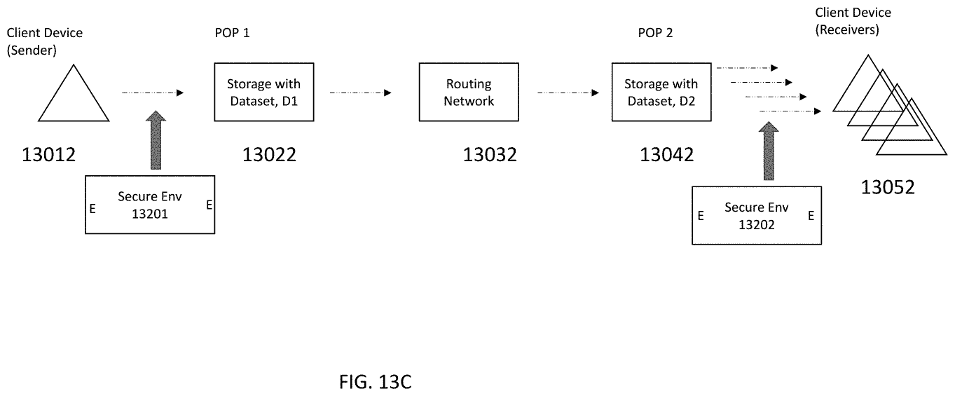

Referring to FIG. 13A, we consider the dataflow for a one-to-one chat service offered by many messaging systems in which a sender transmits a message from a user computing device 1301 to a receiving user computing device 1305. Storage systems 1302 and 1304 are intermediary systems used by the service infrastructure. In the literature, storage systems 1302 and 1304 are sometimes referred to as points of presence (POP) access points A routing network 1303 connects the POP access points 1 and 2.

In practice, client devices 1301 and 1305 negotiate and settle on encryption and decryption keys in a provisioning step without informing the service provider (not shown in FIG. 13A). Therefore, the service provider may claim that it is unaware of the content of the messages being shared between user computing devices 1301 and 1305 since the messages are encrypted and decrypted by the client devices.

A group chat service such as illustrated in the pipeline of FIG. 13B may be considered as a general case of a one-to-one messaging service such as shown in FIG. 13A. In this example user computing device 13011 sends a message to a group of user computing devices 13051. However, notably, whereas one-to-one message services typically encrypt the message content, group chat services generally do not because encryption/decryption keys would have to be individually negotiated for each sender/recipient pair, which is computationally expensive and cumbersome. In practice, the service provider may choose a common encryption/decryption key for the group, but in this case the service provider may now no longer claim that it is unaware of the contents of the message.

Referring now to FIG. 13C, to preserve the claim of the service provider that it remains oblivious of the message content being shared in a group chat, we propose using a secure computing environment 13201, which is introduced between the user computing device 13012 and POP1 and wherein a computer program, say P1 in secure computing environment 13201, negotiates with the user computing device 13012 an encryption/decryption key for sending and receiving messages. Similarly, we introduce in FIG. 13 C a secure computing environment 13202 between POP 2 and user computing devices 13052 wherein a program, say P2 In secure computing environment 13202, negotiates decryption/encryption keys with the respective client devices for receiving and sending messages in a provisioning step (i.e., when the group is formed).

Since the contents of secure computing environments 13201 and 13202 are not visible to any external entity, the service provider may now continue to claim that it is oblivious to the encryption/decryption keys being negotiated between the client devices.

Optionally, secure computing environment 13201 may be provisioned with another computer program, say Z, which establishes a network connection with a service provider, say G (i.e., G may be different from the provider of the messaging/chat service). Program Z, for example, may review a message being sent from user computing device 13012 and inform program Z if certain features are detected. For example, if program Z may be examining content for pornography and service provider G may be operating in conjunction with a law enforcement agency. In such a use case, the chat/messaging service provider remains oblivious of the message contents but is able to alert/inform relevant authorities or service providers when the content of a message triggers an alert condition. Additionally and optionally, service provider G may use program Z to gather statistics which it may then share with the chat/messaging service provider.

Service providers using secure ETL pipelines as described above to provide computational results to customers may optionally provide additional features as described in the following five embodiments.
1. A customer of the result of a secure data pipeline process may want to ascertain that the lineage of the results contains a specific and pre-determined asset (a program or a dataset). This can be provided, as described above, by providing (using a “forked” secure and isolated pipeline segment) cryptographic digests of the pre-determined assets to the customer.
2. A customer of the result of a secure data pipeline process may wish to ascertain that the lineage of the results contains a group of linked assets (e.g., a specific program, say P, operating on a specific dataset, D). This may be achieved by linking the cryptographic digests of the assets and providing the linked digests to the customer using a forked secure pipeline segment (as in embodiment 1 above). For example, we may take the digest of program P and then take the digest of D and P, i.e., digest (D, digest (P union “empty set”)).
3. The secure data pipeline operator may wish to add an additional asset to a pipeline. For example, a pipeline uses asset D1, but the operator may wish to also use asset D2. We can use asset D2 in a forked secure pipeline and provide verifiable assurance (as in embodiment 1 above) that the required asset was used in the pipeline. The original secure data pipeline (using asset D1) remains unaltered.
4. Optionally, in embodiment 3 above, the asset D2 may be provided by the customer (i.e., the recipient of the result of the pipeline). Thus, an intended recipient may obtain customized results using assets specified by the recipient.
5. Typically, resulting datasets of a secure data pipeline process are provided to the customer as an “all you can eat” charging model. (The customer “owns” the result.) However, the result of an ETL pipeline may be provided to the customer in a secure pipeline. That is, the final stage of the ETL pipeline may be a secure pipeline segment. For example, this final segment may be configured to respond to queries posed by the customer and the customer may be charged on a per query basis. Thus, the original charging “all you can eat” model may be replaced by a “pay by the query” model.

Illustrative Computing Environment

As discussed above, aspects of the subject matter described herein may be described in the general context of computer-executable instructions, such as computer programs, being executed by a computer or a cluster of computers. Generally, computer programs include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Also, it is noted that some embodiments have been described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

The claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable storage medium embedded with a computer executable program, which encompasses a computer program accessible from any computer-readable storage device or storage media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). However, computer readable storage media do not include transitory forms of storage such as propagating signals, for example. Of course, those skilled in the art will recognize many modifications may be made to this configuration without departing from the scope or spirit of the claimed subject matter.

As used herein the terms “software,” computer programs,” “programs,” “computer code” and the like refer to a set of program instructions running on an arithmetical processing device such as a microprocessor or DSP chip, or as a set of logic operations implemented in circuitry such as a field-programmable gate array (FPGA) or in a semicustom or custom VLSI integrated circuit. That is, all such references to “software,” computer programs,” “programs,” “computer code,” as well as references to various “engines” and the like may be implemented in any form of logic embodied in hardware, a combination of hardware and software, software, or software in execution. Furthermore, logic embodied, for instance, exclusively in hardware may also be arranged in some embodiments to function as its own trusted execution environment.

Moreover, as used in this application, the terms “component,” “module,” “engine,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediary components. Likewise, any two components so associated can also be viewed as being “operably connected”, or “operably coupled”, to each other to achieve the desired functionality.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments.

1. A method of processing a dataset in a sequence of steps that define at least a portion of a data pipeline, comprising:
providing a plurality of trusted and isolated computing environments, wherein a trusted computing environment is a computing environment whose computer code is able to be attested by comparing a digest of the computing environment to a baseline digest of the computing environment that is available to third parties to thereby verify computing environment integrity, an isolated computing environment being a computing environment in which only a specified maximum number of application processes and specified system processes implementing the computing environment are able to operate;
providing one or more algorithms in each of the trusted and isolated computing environments, the one or more algorithms in each of the trusted and isolated computing environments being configured to process data in accordance with a different step in the data pipeline;
receiving the dataset in a first of the trusted and isolated computing environments and causing the dataset to be processed by the one or more algorithms therein to produce a first processed output dataset; and
causing the first processed output dataset to be processed in a second of the trusted and isolated computing environments by the one or more algorithms therein.

2. The method of claim 1 wherein the sequence of steps in the data pipeline performed in the plurality of trusted and isolated computing environments define a segment of a larger data pipeline that includes one or more additional data processing steps.

3. The method of claim 1 wherein the plurality of trusted and isolated computing environments includes at least three trusted and isolated computing environments, the data pipeline processing the dataset in accordance with an E-T-L (Extraction-Transformation-Load) dataflow such that an extraction step, a transformation step and a load step are each performed in a different one of the trusted and isolated computing environments.

4. The method of claim 1 wherein the dataset provided in the first trusted and isolated computing environment is provided by a third party different from a third party providing the one or more algorithms provided in the first trusted and isolated computing environment, the third parties both being different from a system operator or operators of the plurality of trusted and isolated computing environments.

5. The method of claim 1 wherein the extraction step obtains data for processing from user computing devices and stores the data in encrypted form.

6. A method of processing data in a sequence of steps that define at least a portion of a data pipeline, comprising:
providing at least three trusted and isolated computing environments, wherein a trusted computing environment is a computing environment whose computer code is able to be attested by comparing a digest of the computing environment to a baseline digest of the computing environment that is available to third parties to thereby verify computing environment integrity, an isolated computing environment being a computing environment in which only a specified maximum number of application processes and specified system processes implementing the computing environment are able to operate;
providing one or more algorithms in each of the trusted and isolated computing environments, the one or more algorithms in each of the trusted and isolated computing environments being configured to process data in accordance with a different step in the data pipeline;
receiving a first dataset in a first of the trusted and isolated computing environments and causing the first dataset to be processed by the one or more algorithms therein to produce a first processed output dataset, at least one of the algorithms processing the first dataset in the first trusted and isolated computing environment being a first Deep Learning Neural Network (DLNN) program;
receiving a second dataset in a second of the trusted and isolated computing environments and causing the second dataset to be processed by the one or more algorithms therein to produce a second processed output dataset, at least one of the algorithms processing the second dataset in the second trusted and isolated computing environment being a second DLNN program; and
causing the first and second processed output datasets to be processed in a third of the trusted and isolated computing environments by the one or more algorithms therein.

7. The method of claim 1 wherein the first and second processed output datasets include values for internal weights of the first and second DLNN programs.

8. The method of claim 7 wherein at least one of the algorithms in the third trusted and isolated computing environment is a third DLNN program that combines the internal weights of the first and second DLNN programs and provides the combined internal weights to a fourth trusted and isolated computing environment that has a fourth DLNN program for processing the combined internal weights.

9. A method for establishing an encryption/decryption process for communicating messages between at least one sending computing device and at least one receiving computing device over a data pipeline that includes a plurality of point of presence (POP) access points and a routing network, comprising:
negotiating use of one or more specified encryption/decryption keys between the sending computing device and a first algorithm operating in a first trusted and isolated computing environment that communicates with one of the POP access points, the one or more specified encryption/decryption keys being used to encrypt messages sent by the sending computing device to the receiving computing device, wherein a trusted computing environment is a computing environment whose computer code is able to be attested by comparing a digest of the computing environment to a baseline digest of the computing environment that is available to third parties to thereby verify computing environment integrity, an isolated computing environment being a computing environment in which only a specified maximum number of application processes and specified system processes implementing the computing environment are able to operate; and
negotiating use of one or more specified decryption/encryption keys between the receiving computing device and a second algorithm operating in a second trusted and isolated computing environment that communicates with one of the POP access points, the one or more specified decryption/encryption keys being used to decrypt messages by the receiving computing device from the sending computing device.
